(19) United States
(12) Patent Application Publication
(10) Pub. No.: US 2006/0226383 A1
(43) Pub. Date: Oct. 12, 2006

(54) Micro-flow valve

(76) Inventor: Loyal G. Murphy, Milford, MA (US)

Correspondence Address: HODGSON RUSS LLP, ONE M & T PLAZA, SUITE 2000, BUFFALO, NY, 14203-2391, US

(21) Appl. No.: 11/255,183

(22) Filed: Oct. 19, 2005

Related U.S. Application Data
(60) Provisional application No. 60/620,180, filed on Oct. 19, 2004.

(51) Int. Cl. F16K 7/04

(52) U.S. Cl. 251/7

(57) ABSTRACT

A micro-flow valve for low flow rate gases or liquids.

### CROSS-REFERENCE TO RELATED APPLICATION

The present application claims benefit of U.S. Provisional Patent Application No. 60/620,180, filed on Oct. 19, 2004, entitled “Micro-Flow Valve.”

### BRIEF DESCRIPTION OF THE DRAWINGS

The invention is illustrated in the drawings in which like reference characters designate the same or similar parts throughout the figures of which:

FIG. 1 is a cross-sectional side elevational view of an embodiment of the present invention;

FIG. 2 is a cross-sectional side elevational view of an alternate embodiment of the present invention;

FIG. 3 is a side view of an aspirator-type mixing head incorporating the present invention;

FIG. 4 is a top view of the aspirator-type mixing head of FIG. 3;

FIG. 5 is a bottom view of the aspirator-type mixing head of FIG. 3; and

FIG. 6 is a block diagram of the aspirator mixing system incorporating the present invention.

### DETAILED DESCRIPTION OF THE INVENTION

In FIG. 1, a micro-flow valve for low flow rate gases or liquids is shown. A valve cartridge 10 having flexible containing walls 13 forms a passageway for the flow of liquid or gas indicated by compression force arrows 16. A set of opposed adjustment jaws 22 provides the adjustment means. A resilient, open-cell synthetic foam material 19 is disposed inside the valve cartridge 10. The open-cell structure of the foam forms a multitude of contiguous and interlocking passageways that allows a certain amount of liquid or gas to pass through the cell openings. When the material 19 is compressed, the amount of liquid or gas that is capable of passing through the material 19 is reduced because the size and number of passages in the open-cell structure is reduced. The material 19 may be compressed to adjust the flow rate by clamping the containing walls from the outside by means of the pair of opposed adjustment jaws 22. The adjustment jaws 22 can be used to squeeze the opposed containing walls 13 together thus compressing the material 19. Other materials may be substituted for the open cell foam such as, but not limited to, porous non-woven fabrics such as needle punch or spun bond nylon, polypropylene (PP) or polyethylene (PE).

The opposed adjustment jaws 22 are mechanically coupled as will be evident to those of ordinary skill in the art. The present invention performs better than precision metering orifices because it is continuously variable and resists clogging. The invention provides a much finer degree of control than can be achieved by compression of a hollow flexible tube.

Compression of the tube containing the open-cell structure synthetic foam causes flattening of the foam cells thereby restricting the liquid or gas flow. The multitude of flow paths through the foam allows for a very gradual shut-off of the valve providing precise control of “seepage” flow. This multitude of flow paths also prevents particles from blocking the valve as can occur with fixed orifices or needle valves.

As will be evident to those of ordinary skill in the art, liquid or gas flow through the valve is produced by creating a pressure differential between the input and output ports with flow toward the lower pressure port. Performance of the valve is a function of the following parameters: pressure differential between ports; foam density; size of the openings in the foam material; cross-sectional area of the foam material; length of the foam material; length of the jaws; degree of compression of the foam material. The performance of the valve can be optimized for specific applications by appropriate selection of the above parameters.

The valve cartridge may be replaceable and may be connected in a system by common tube clamps, compression connectors or press-fit sockets, depending on fluid/gas pressure and other mechanical requirements.

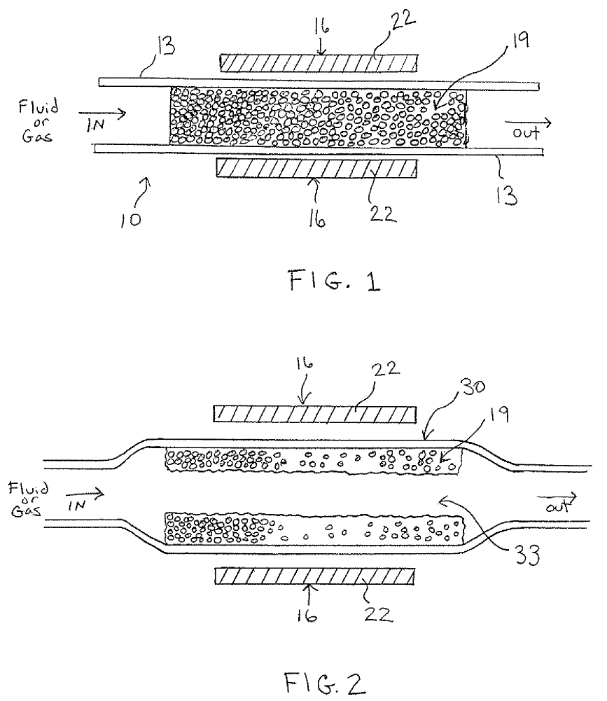

In FIG. 2, an alternate embodiment of the adjustable flow valve is shown. The valve 30 has maximum flow position with a central passageway 33 that bypasses the open-cell structure foam material 19. Accordingly, maximum flow is enhanced by the bypass channel or passageway 33. When the adjustment jaws 35 are forced together in the direction of compression force arrows 16, the open-cell structure foam material 19 is first brought together to block the central passageway 33 and then further closure of the jaws 22 causes the material 19 to be compressed as described above. Accordingly, there is a greater range of flow rates available in comparison to the flow rates for the embodiment shown in FIG. 1.

The valve of the present invention can be specifically designed to achieve full flow to full shut-off or limited range applications. The tube and foam must be chemically compatible with the liquid or gas that is being controlled.

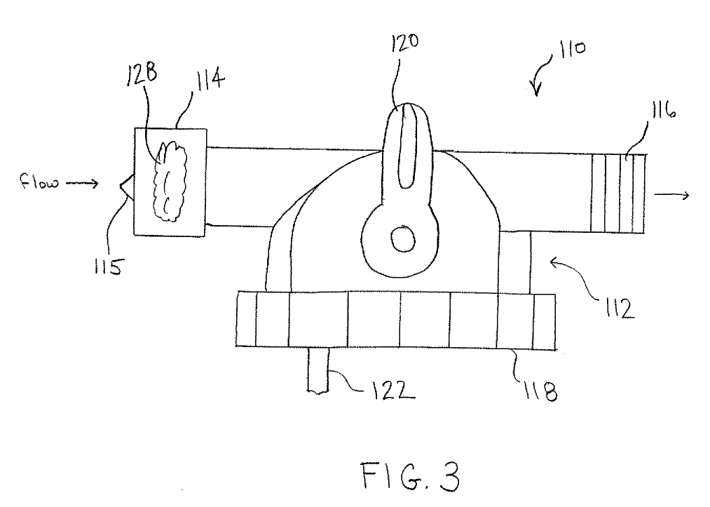

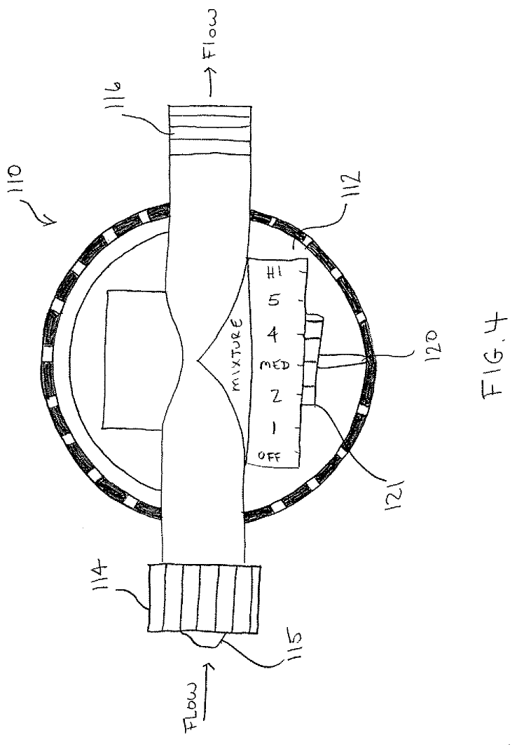

Turning to FIG. 3, which shows one example of an application where the micro-flow valve of the present invention may be utilized, an aspirator-type mixing head 110 may be constructed of metal, plastic, or other suitable rigid materials. The mixing head 110 may include a cap 112 having a female coupler 114, a male coupler 116, and a container attachment ring 118. The female coupler 114 and the male coupler 116 may be threaded for attachment to a hose (not shown). A screen 115 may also be fitted inside the female coupler 114 to filter particles from the flow of liquid entering the mixing head 110. An anti-siphon check valve 128 prevents source contamination due to reverse flow of mixed liquid when flow is shut off at the nozzle. Other connection means for attaching the mixing head 110 to a hose may also be utilized. The container attachment ring 118 may be any type of suitable connection to attach the mixing head 110 to a container 113 containing the chemical, or other product, to be diluted.

The mixing head 110 may also contain a mixture control lever 120, which may be adjusted to control the degree of dilution of the chemical mixture.

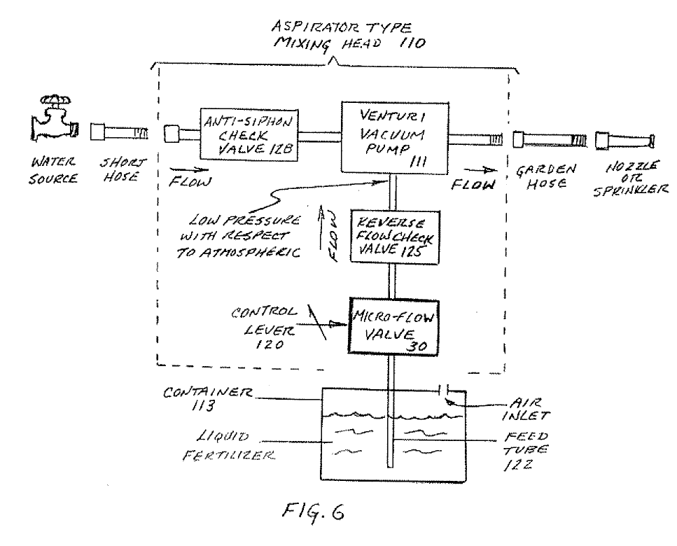

A feed tube 122 may be connected at one end to the mixing head 110, and may extend into the container 113. The product to be diluted is conveyed by means of a Bernoulli-type venturi pump 111 (FIG. 5) that produces a vacuum. The product to be diluted is carried through the feed tube 122 then through the micro-flow valve cartridge 138 and into the mixing head 110 where the product is diluted and carried through the male coupler 116 to a hose or other attachment (not shown).

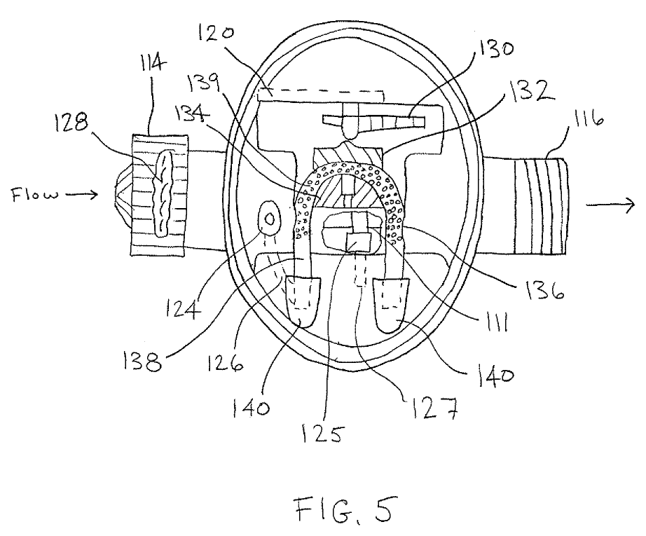

A top view of the mixing head 110 is shown in FIG. 4. The mixture control lever 120 and mixture dial 121 may have markings indicating varying levels of dilution of the product allowed to flow out of the mixing head 110 through the male coupler 116. The degree of dilution of the product is controlled by a user (not shown) by turning the mixture control lever 120 to the desired position on the mixture dial 121. The mixture control dial 121 has various settings for different dilution levels such as OFF at the bottom, LOW for a minimum amount of product delivered to the mainstream flow, and HIGH indicates a maximum amount of product delivered to the mainstream flow.

The mixing head 110 is shown from the bottom in FIG. 5. Liquid flows through the mixing head 110 from the direction of the female coupler 114 to the male coupler 116. A venturi vacuum pump 111 located between the couplers 114 and 116 is used to draw a liquid chemical product from the container to be injected into the mainstream flow within the mixing section of the venturi vacuum pump 111. The chemical product in the container 113 is drawn into the feed tube 122 which connects to the feed tube socket 124 located on the bottom of the cap 112, as shown in FIG. 5. The suction tube socket is connected to the valve cartridge socket within the cap by internal suction tube A 126.

The micro-flow valve cartridge 138 includes an open-cell structure synthetic foam member 139 which functions as described above in connection with FIGS. 1 and 2. An adjustment cam 130 connected to the control lever 120 engages with sliding jaw 132 on one side of the valve and a fixed jaw 134 engages with the other side to provide an adjustable compressive force for controlling the flow rate of the additive liquid or gas through the open-cell foam 139. The highest point on the cam is the OFF position at which the valve is fully compressed as shown in FIG. 5.

Internal suction tube B 127 connects the valve cartridge socket 140 at the output of the valve to a reverse flow check valve 125 and finally to the venturi pump 111. The check valve 125 prevents back-flow to the container from the source if output flow is stopped.

The chemical product is then mixed with the mainstream flow within the mixing section of the venturi pump 111 and exits the mixing head 110 through male coupler 116.

FIG. 6 is a block diagram of this application of the subject valve. In FIG. 6, the arrangement of the vacuum pump 111, the reverse flow check valve 125, the micro-flow valve mechanism 138, feed tube 122, and container 113 is shown.

### PARTS LIST

110 aspirator-type mixing head
111 venturi pump
112 cap
113 container
114 female coupler
115 screen
116 male coupler
118 container attachment ring
120 mixture control lever
121 mixture dial
122 feed tube
124 feed tube socket
125 reverse flow check valve
126 internal suction tube A
127 internal suction tube B
128 anti-siphon check valve
130 adjustment cam
132 sliding jaw 134 fixed jaw
136 tube restraint
138 micro-flow valve cartridge (tube with foam)
139 open-cell synthetic foam
140 valve cartridge socket
10 valve cartridge
13 containing walls
16 compression force arrows
19 open-cell synthetic foam material 22 adjustment jaws
30 valve
33 passageway

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

1. An adjustable “micro-flow” valve which provides an extended range of control of very low flow rates of liquids or gasses.

2. A micro-flow valve according to claim 1 which resists clogging by particulates in the liquid or gas flow.

3. A micro-flow valve which employs a replaceable cartridge allowing periodic renewal of performance in gradual clogging applications.

4. A micro-flow valve mechanism, as applied in an aspirator-type mixing head, having one or more of the features described herein.
